(19) United States
(12) Patent Application Publication
(10) Pub. No.: US 2004/0165855 A1
(43) Pub. Date: Aug. 26, 2004

(54) HOLDER APPARATUS FOR OPTICAL INTEGRATION ROD

(76) Inventors: Chia-Chang Lee, Hsin-Chu City (TW); Chih-Wei Tsai, Hsin-Chu City (TW); Ching-Sheng Chang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,207

(22) Filed: Feb. 17, 2004

(30) Foreign Application Priority Data
Feb. 24, 2003 (TW) 092203137

(51) Int. Cl. G02B 6/00

(52) U.S. Cl. 385/137

(57) ABSTRACT

A holding apparatus for an optical integration rod is installed outside of an optical integration rod. It comprises a holder which is a heat sink substrate with fins disposed at the outside surface thereof. A thermal conductivity material is filled in between the holding apparatus and the optical integration rod to allow the heat yielded in the rod to be guided out through the thermal conductivity material and then to be transmitted to the holder to carry away by way of a natural or forced convection manner so as to attain to a heat dissipation effect. Because the holder has a broader heat exchange area and the heat conduction function of the thermal conductivity material is better than air, the heat contact resistance between the holder and the rod can be reduced so as to enhance the heat dissipation efficiency.

### BACKGROUND OF INVENTION

1. Field of the Invention

The present invention relates to an optical integration rod, and more particularly to a holding apparatus for an optical integration rod capable of holding an optical integration rod and strengthening a heat dissipation effect.

2. Description of the Prior Art

Please refer to FIG. 1. A conventional optical integration rod 1 is made by lapng and bonding glass substrates together to form a hollow column type structure, and then, a reflection film is coated on the inside wall of the optical integration rod to allow a beam that enters the rod 1 can be practiced a plurality of reflections through the reflection film so as to form a uniform beam. And, the rod 1 needs to be held by a holder 2 when it is assembled into an optical system in order to prevent from a structure destruction and to attain to an optical positioning requirement. In addition, the system needs a heat dissipation mechanism to move away the heat accumulated in the rod 1 by strong beams to allow the rod 1 to maintain at the best optical operation temperature.

The holder 2 that is a hollow column shape press workpiece is covered outside of the rod 1 and is fixed with the rod by Ultra Violet solidifying glue. Thereafter, an adjustment and clamping devices are used to fix the rod 1 at an accurate optical path. For reducing an acted force on the rod 1 while adjusting, openings 3 might generally be opened at the surface of the holing apparatus in order to reduce the contact area between the rod 1 and the holder 2 and furthermore to be an injection inlet for UV solidifying glue. And, the heat in the rod can be carried away by natural convection between the openings 3 and the system or forced convection by blowing airflow to the rod 1 through an installed fan to attain to a heat dissipation effect.

Although air is used in the conventional optical integration rod 1 as a convection media to guide the heat yielded in the rod 1, air convection coefficient is less than solid conduction coefficient and consequently the heat contact resistance in the rod 1 is high so that the heat dissipation efficiency is rather low. Therefore, for increasing heat dissipation efficiency or dissipating heat successfully, a forced convection way is used, i.e. a fan is further installed to enhance convection. However, the rotation of the fan causes noise that interferences sight enjoyment environment. Moreover, heat taken away by blowing wind directly to the rod 1 is limited because the rod 1 is made from glass material with low convection efficiency. Therefore, the disposition of the conventional openings 3 or the further installment of the fan to yield forced convection cannot dissipate heat efficiently.

### SUMMARY OF INVENTION

One object of the present invention is to provide a holding apparatus for an optical integration rod, using a holder whose outside surface is provided with a design for heat dissipation function, and injecting thermal conductivity material between an optical integration rod and a holder to reduce heat contact resistance to allow the heat yielded in the rod to be dissipated to cooling fluid efficiently through the thermal conductivity material so as to enhance heat dissipation efficiency.

Another object of the present invention is to provide a holding apparatus for an optical integration rod, allowing a holder with same dimension to be suitable for use in every kind dimension of optical integration rod so as to increase use flexibility and lower parts cost.

Still another object of the present invention is to provide a holding apparatus for an optical integration rod, capable of using a heat pipe to transmit the heat yielded in an optical integration rod to the best location for natural convection or forced convection so as to enhance heat dissipation efficiency.

For achieving the objects mentioned above, a holding apparatus is installed outside of an optical integration rod, whose surface has fins. The holder can be a heat sink substrate. And, thermal conductivity material is filled in an interval between the holding apparatus and the optical integration rod. After the heat yielded in the rod is guided out through the thermal conductivity material, it is further transmitted to the holding apparatus by way of natural convection or forced convection manner to carry away the heat to attain to heat dissipation. Furthermore, a heat pipe can be installed with one end thereof it connected to the holder and another end thereof connected to a heat sink.

The heat in the optical integration rod can be transmitted to the best natural or forced convection through the heat pipe to attain to heat dissipation.

### BRIEF DESCRIPTION OF DRAWINGS

The present invention can be more fully understood by reference to the following description and accompanying drawings, in which:

FIG. 1 is a perspective view, showing the conventional assembly of an optical integration rod and a holder;

FIG. 2 is a perspective view, showing a structure of a holding apparatus for an optical integration rod of first preferred embodiment according to the present invention.

FIG. 3 is a sectional view, showing a structure of a holding apparatus for an optical integration rod of second preferred embodiment according to the present invention;

FIG. 4 is a sectional view, showing a structure of a holding apparatus for an optical integration rod of third preferred embodiment according to the present invention;

FIG. 5 is a sectional view, showing a structure of a holding apparatus for an optical integration rod of fourth preferred embodiment according to the present invention;

FIG. 6 is a schematic view, showing positions of temperature measurement spots according to the present invention;

FIG. 7 is graph, showing a comparison between temperatures of the measurement spots at optical integration rods of the prior art and the present invention; and

FIG. 8 is a schematic view, showing a structure of a holding apparatus for an optical integration rod with a heat pipe according to the present invention.

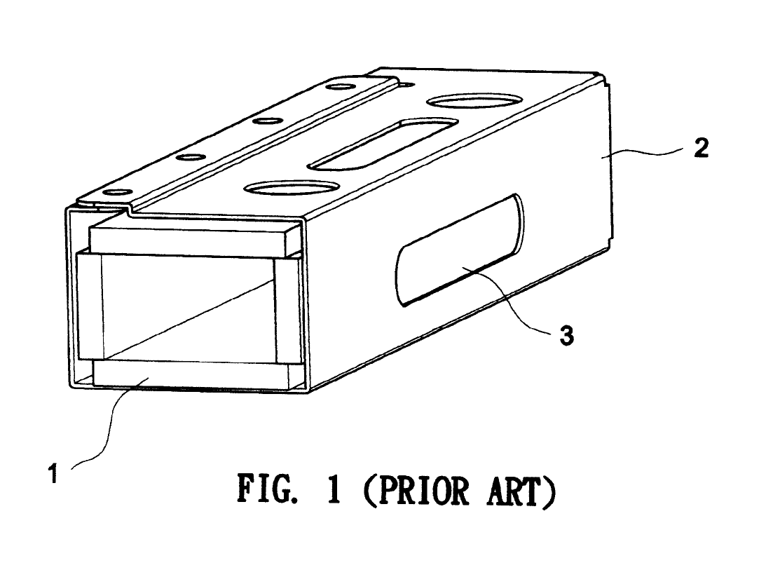

### DETAILED DESCRIPTION

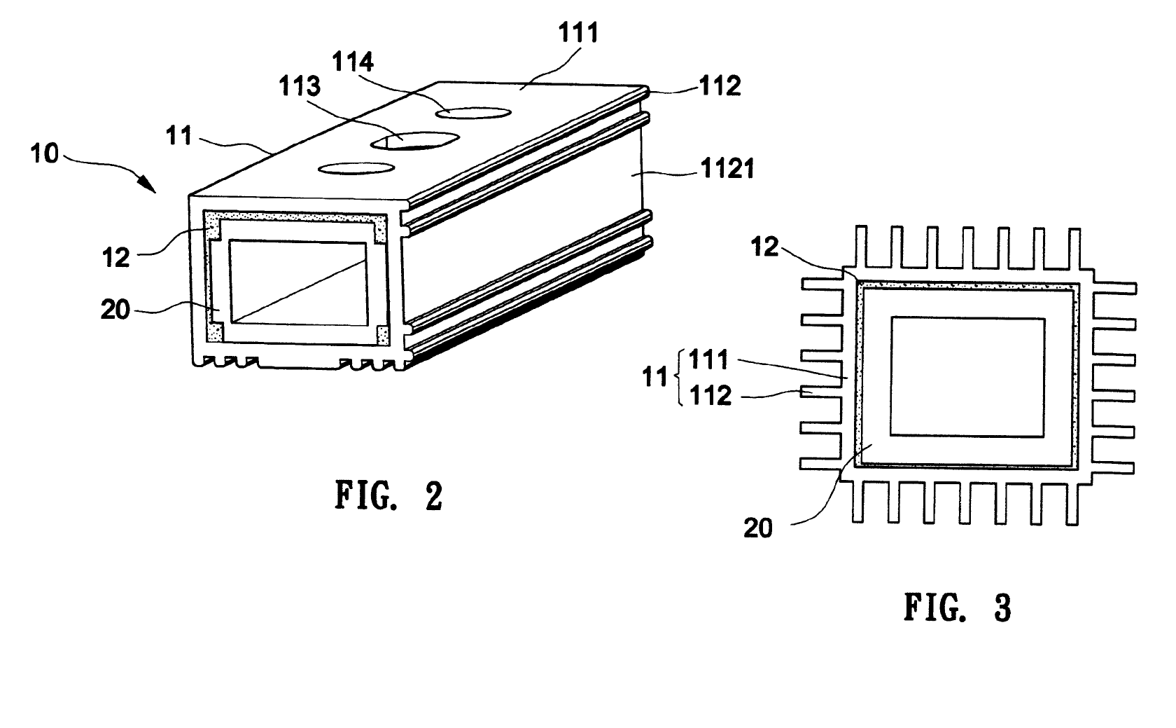

Please refer to FIG. 2. An optical integration rod 10 comprises a holder 11. The holder 11 is installed outside of an optical integration rod 20, and thermal conductivity material 12 is filled in between the holder 11 and the optical integration rod 20. The shape of the holder 11 can be designed according to the space and the shape of the rod 20; the holder 11 in the present invention is a hollow column body for matching up with the rod 20, in which a hollow part is used to accept the rod 20. The holder 11 consists of a heat sink substrate 111 and a plurality of fins 112. The heat sink substrate 111 is made from a high heat conduction coefficient material, such as aluminum and copper. The fins 112 are disposed outside of the two surfaces of the heat sink substrate 111. A flat plane 1121 is disposed between the fins 112 favorable for an adjustment device or clamping apparatus to clamp or prop against.

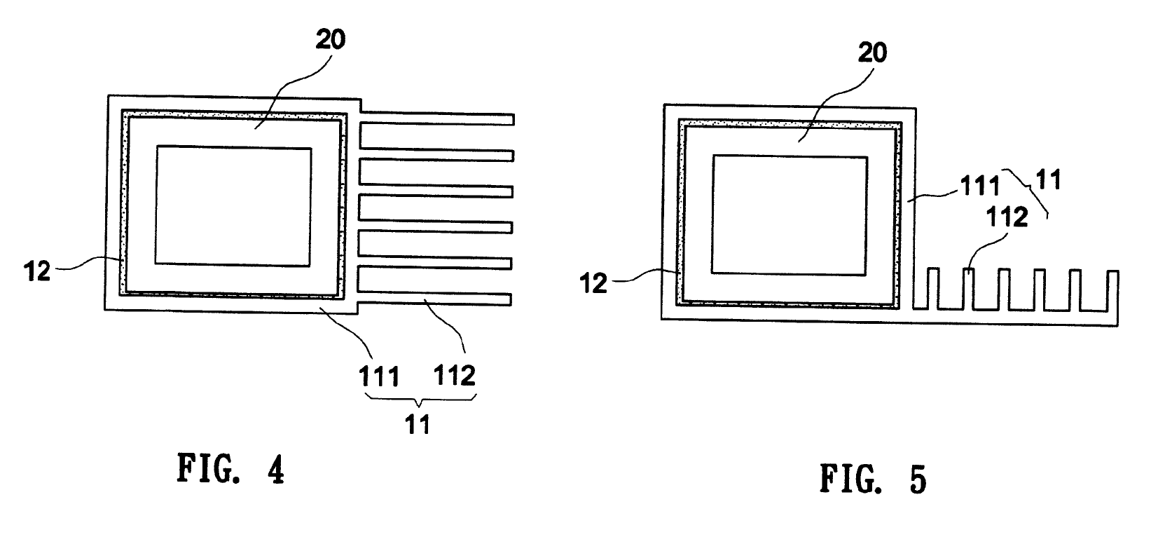

The fins 112 can be disposed at one outside surface of the substrate 111 at least. And, the positions, numbers and dimensions of the fins can be decided according the space and the design of the airflow passages. For example, the fins can be disposed more at the area with a better natural convection so as to increase heat exchange area and heat conduction efficiency. Besides, the fins can be disposed at the surroundings of the substrate 111 (as shown in FIG. 3), one flank face thereof (as shown in FIG. 4), a face extended from one end of the substrate 111 (as shown in FIG. 5) and etc.

Next, please refer to FIG. 2. At least a first glue filling hole 113 and second filling hole 114 are disposed at the surface of the holder 11 to allow the holder 11 and the rod 20 to stick together after the higher viscosity glue (e.g. UV solidifying glue) is injected into the first glue filling hole and a thermal conductivity material 12 is filled in slits between the rod 20 and the holder 11 after it is injected into the second glue filling hole 114. Therefore, a fixed dimension holder can be used on every different dimension of optical integration rod by filling the thermal conductivity material 12 so as to enhance use flexibility and lower parts cost. Besides, the thermal conductivity material 12 can be used to lower heat contact resistance and to increase heat conduction effect.

The heat yielded in the rod 20 can be transmitted to the holder 11 and the outside fins 112 through the thermal conductivity material 12, and then carried away by the natural convection in the system to attain to heat dissipation. Because the heat yielded in the rod 20 is guided out to the holder 11 through the thermal conductivity material 12 according to the present invention, the heat conduction effect in the present invention is better than the one in conventional apparatus that takes fluid as a heat conduction media. And, the heat is transmitted to the holder 11 with a high heat conduction coefficient and broader heat exchange area and is then expelled without practicing direct heat dissipation to the rod 20. Therefore, the heat dissipation efficiency can be enhanced. Besides, a forced convection manner can be further used to increase the heat exchange phenomena so as to enhance the heat dissipation effect.

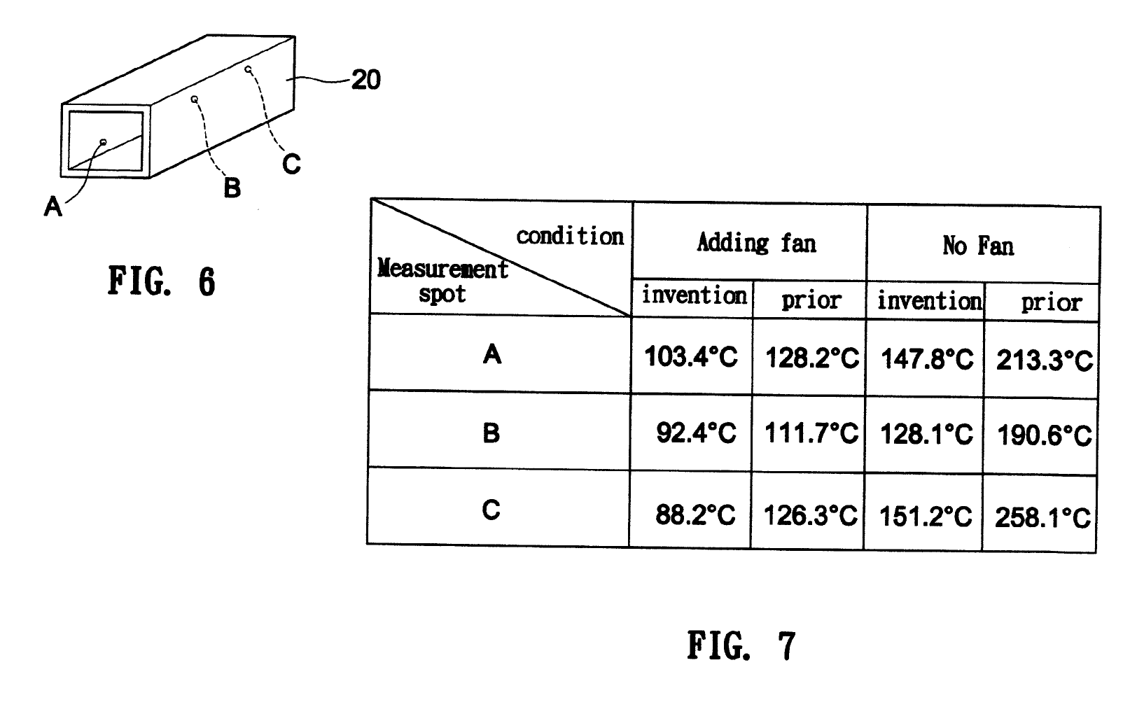

Please refer to FIG. 6. The holding apparatus according to the present invention and the conventional holding apparatus are respectively installed in a same optical system and temperature detection spots A, B and C are respectively disposed at the inlet, the center and the exit of the rod 20. Thereafter, temperature measurements are processed at 30 minutes after the system is turned on. A measurement result is shown in FIG. 7. When a fan with a driving voltage 8V is added at the outside of the rod 20, the temperatures at the spots A and B can be lowered 20° C. and the temperature at the spot C can be lower 38° C. And, when no fan is installed at the outside of the rod 20, the temperatures at the spots A and B can be lower approximately 65° C. and the temperature at the spot C can be lowered 106° C. It is known from the experiment data that the holding rod of an optical integration rod according to the present invention can broadly decrease the temperature of an optical integration rod so as to provide a higher heat dissipation effect.

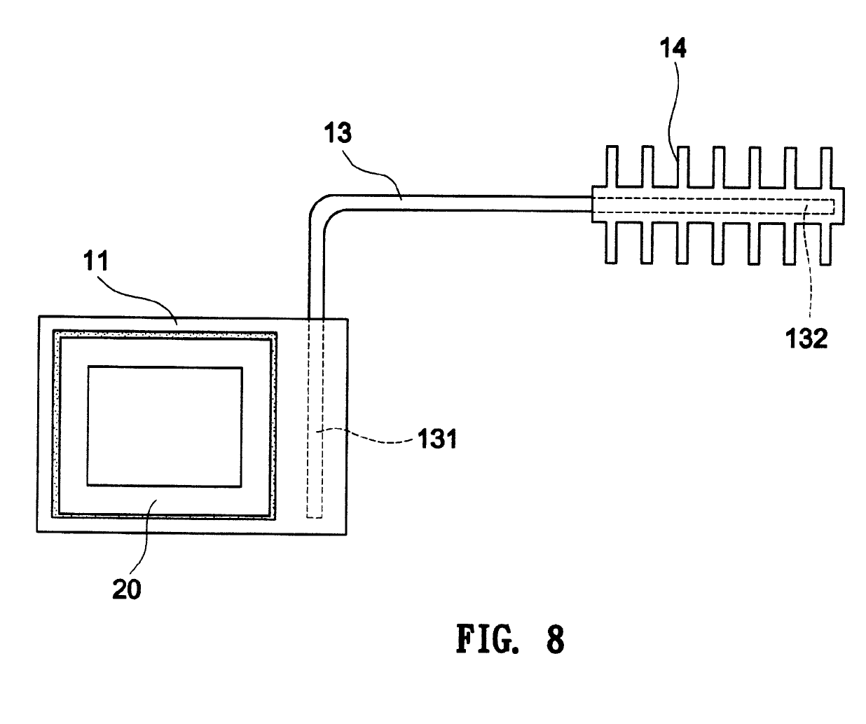

Furthermore, when a cooling space is limited owing to limited space around an optical integration rod and dustproof requirement, a heat pipe 13 can be used to transmit the heat in the holder 11 to the place that natural convection is better or forced convection is available to process heat dissipation. Please refer to FIG. 8. A vaporization terminal 131 of the heat pipe 13 is connected to the holder 11 and a condensing end 132 thereof is connected to a heat sink 14. The heat sink 14 can be a heat sink sheet with fins, low temperature water tank (not shown in the figure) or other else. The heat in the holder 11 is transmitted to the heat sink 14 through the heat pipe 13 and than cooled so as to attain to heat dissipation. It is noted that the holding apparatus for an optical integration rod described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is to claimed is:

1. A holding apparatus for an optical integration rod, comprising a holder, installed outside of said optical integration rod, wherein a thermal conductivity material is filled in between said holder and said optical integration rod.

2. The holding apparatus according to claim 1, wherein said holder is a heat sink substrate.

3. The holding apparatus according to claim 2, wherein said heat sink substrate is a high heat conduction coefficient material.

4. The holding apparatus according to claim 2, further comprising fins which are disposed on said heat sink substrate.

5. The holding apparatus according to claim 4, wherein said fins can be disposed at one side of said heat sink substrate at least.

6. The holding apparatus according to claim 1, wherein said holder is a hollow column.

7. The holding apparatus according to claim 1, further comprising at least a glue filling hole is disposed at the surface of said holder.

8. The holding apparatus according to claim 1, further comprising one end of a heat pipe is connected to said holder and another end thereof is connected to a heat sink apparatus.

9. The holding apparatus according to claim 8, wherein said heat sink apparatus is a heat sink sheet.
